(19) United States
(12) Patent Application Publication
(10) Pub. No.: US 2014/0293911 A1
(43) Pub. Date: Oct. 2, 2014

(54) METHOD OF SHARING CHANNEL INFORMATION IN WIRELESS LOCAL AREA NETWORK (WLAN) SYSTEM

(71) Applicant: Electronics and Telecommunications Research Institute, Daejeon (KR)

(72) Inventors: Min Ho CHEONG, Daejeon (KR); Sok Kyu LEE, Daejeon (KR)

(73) Assignee: Electronics and Telecommunications Research Institute, Daejeon (KR)

(21) Appl. No.: 14/242,197

(22) Filed: Apr. 1, 2014

(30) Foreign Application Priority Data
Apr. 1, 2013 (KR) 10-2013-0035226
Mar. 31, 2014 (KR) 10-2014-0038104

(51) Int. Cl. H04L 5/00

(52) U.S. Cl. CPC H04L 5/003
USPC 370/329

(57) ABSTRACT

Provided is a method of sharing channel information performed by an access point (AP), the method including setting a master AP among adjacent APs, adjusting time stamp information on a point in time for communication based on a beacon received from the adjacent APs, estimating a carrier frequency offset (CFO) using a packet received from the master AP, and readjusting the time stamp information based on the estimated CFO.

### CROSS-REFERENCE TO RELATED APPLICATION

This application claims the priority benefit of Korean Patent Application No. 10-2013-0035226, filed on Apr. 1, 2013, and Korean Patent Application No. 10-2014-0038104, filed on Mar. 31, 2014, in the Korean Intellectual Property Office, the disclosure of which is incorporated herein by reference.

### BACKGROUND

1. Field of the Invention

The present invention relates to a method of sharing channel information in a wireless local area network (WLAN) system.

2. Description of the Related Art

A local area network (LAN) may be divided into a wired LAN and a wireless LAN (WLAN). Through the WLAN, communication may be performed using radio waves in lieu of cables. The WLAN is provided to overcome a difficulty in installation, maintenance, and relocation of a cable. With an increase in a number of mobile network users, a necessity of the WLAN is correspondingly increasing.

The WLAN may include an access point (AP) and a terminal, for example, a station (STA). The AP may be a device for transmitting radio waves to allow WLAN users located within a transmission distance to access the Internet and use a network. The AP may also perform a function of a hub in the wired network or a base station of a cellular phone. The AP has been installed in an area providing a wireless high-speed Internet service provided by an Internet service provider (ISP).

A basic configuration block of an Institute of Electrical and Electronics Engineers (IEEE) 802.11 network is a basic service set (BSS). The IEEE 082.11 network may include an independent BSS in which terminals included in the BSS communicate directly with each other, an infrastructure BSS in which the AP is used in a communication process between a terminal and another terminal located inside or outside of the BSS, and an extended service set to extend a service area by connecting various types of the BSS to one another.

In general, an IEEE 802.11 based WLAN system may access a medium based on a carrier sense multiple access/collision avoidance (CSMA/CA) scheme, and each AP may operate independently. Thus, the WLAN system may not adopt a scheme of allocating a channel using a separate device. In addition, when a power supplied the AP is turned on, each AP may independently select a channel using an operator or a channel allocation algorithm. Due to this, a channel used by each BSS may overlap when many WLAN systems are provided. When the channel overlaps, interference may occur between adjacent BSSs. Also, due to a popularization of the WLAN system, APs may be densely distributed in an identical space and thus, a probability of an occurrence of interference may also increase.

When radio wave radiation devices not included in an identical BSS radiate radio waves from a distance sufficiently close to affect WLAN communication devices included in the identical BSS, an error may occur in a communication process being performed by the WLAN communication devices based on a predetermined rule.

An interference alignment scheme may be suggested to solve the issue of such interference. In the interference alignment scheme, an AP may select an STA to perform communication based on data received from the STA. To improve a performance of an interference alignment, a timing between the AP and the STA and a timing among APs included in the WLAN system may need to be synchronized.

### SUMMARY

According to an aspect of the present invention, there is provided a method of sharing channel information, the method including setting a master access point (AP) among adjacent APs, adjusting time stamp information on a point in time for communication based on a beacon received from the adjacent APs, estimating a carrier frequency offset (CFO) using a packet received from the master AP, and readjusting the time stamp information based on the estimated CFO.

The adjusting may include extracting time stamp information from the beacon received from the adjacent APs, and adjusting time stamp information on the AP based on the extracted time stamp information.

The method of sharing channel information may further include broadcasting a beacon including time stamp information on a point in time for communication.

According to another aspect of the present invention, there is also provided a method of sharing channel information, the method including setting time stamp information on a point in time for communication based on reference clock information received from a controller, adjusting the time stamp information using a packet received from the controller, estimating a CFO using the packet, and adjusting the time stamp information based on the estimated CFO.

According to still another aspect of the present invention, there is also provided a method of sharing channel information, the method including transmitting, to an adjacent AP, information on a station (STA) connected to the AP and information for use in communication between the STA and the AP, and extracting scheduling information on the adjacent AP from a beacon received from the adjacent AP.

The information for use in communication between the AP and the STA may include information on a restricted access window (RAW) allocated to the STA and a slot allocated in the RAW.

The transmitting may include generating a frame including at least one of address information on the AP, address information on the STA connected to the AP, information on a number of antennas included in the AP, and transmission stream information, and transmitting the generated frame to an STA or an adjacent AP.

According to yet another aspect of the present invention, there is also provided an AP including a channel information adjuster to adjust time stamp information on a point in time for transmission based on a beacon received from adjacent APs, and a CFO estimator to estimate a CFO using a packet received from a master AP or a controller, wherein the channel information adjuster readjusts the time stamp information based on the estimated CFO.

The AP may further include a communicator to broadcast a beacon including time stamp information on a point in time for transmission.

The AP may further include a scheduling unit to perform a scheduling between an uplink transmission and a downlink transmission, and a scheduling between a transmission time of the AP and a transmission time of an adjacent AP.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an interference environment of a wireless local area network (WLAN) system;

FIG. 2 is a block diagram illustrating a configuration of an access point (AP) according to an example embodiment;

FIG. 3 is a flowchart illustrating sharing of channel information according to an example embodiment;

FIG. 4 is a flowchart illustrating sharing of channel information according to another embodiment;

FIG. 5 is a flowchart illustrating sharing of channel information according to still another embodiment;

FIG. 6 is a diagram illustrating a process of using a slotted carrier sense multiple access (CSMA) to perform an operation of interference alignment according to an example embodiment;

FIG. 7 is a diagram illustrating an example of a protocol for use in channel information sharing according to an example embodiment; and

FIG. 8 is a diagram illustrating a frame for use in channel information sharing according to an example embodiment.

### DETAILED DESCRIPTION

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes specific details in order to provide a thorough understanding of the present invention. However, it will be apparent to those skilled in the art that the present invention may be practiced without such specific details.

The following embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies hereinafter used in the embodiments of the present invention are provided to assist understanding of the present invention, and various modifications may be made in the specific terminologies within the range that they do not depart from technical spirits of the present invention.

In some instances, known structures and devices are omitted or are shown in block diagram form, focusing on important features of the structures and devices, so as not to obscure the concept of the invention. The same reference numbers will be used throughout this specification to refer to the same or like parts.

The embodiments of the present invention may be supported by standard documents disclosed in at least one of wireless access systems, i.e., an Institute of Electrical and Electronics Engineers (IEEE) 802 system, a third generation partnership project (3GPP) system, a 3GPP long term evolution (LTE) system, an LTE-Advanced system, and a 3GPP2 system. Namely, among the embodiments of the present invention, steps or parts which are not described to clarify the technical features of the present invention may be supported by the above standard documents. Also, all terminologies disclosed herein may be described by the above standard documents.

The following technology may be used for various wireless access systems such as code division multiple access (CDMA), frequency division multiple access (FDMA), time division multiple access (TDMA), orthogonal frequency division multiple access (OFDMA), and single carrier frequency division multiple access (SC-FDMA). The CDMA may be implemented by radio technology such as universal terrestrial radio access (UTRA) or CDMA 2000. The TDMA may be implemented by radio technology such as global system for mobile communications (GSM)/general packet radio service (GPRS)/enhanced data rates for GSM evolution (EDGE). The OFDMA may be implemented by radio technology such as IEEE 802.11 (Wi-Fi), IEEE 802.16 (WiMAX), IEEE 802-20, and evolved UTRA (E-UTRA). Although the following description will be based on the IEEE 802.11 system to clarify description of technical features, it is to be understood that technical spirit of the present invention is not limited to the IEEE 802.11 system.

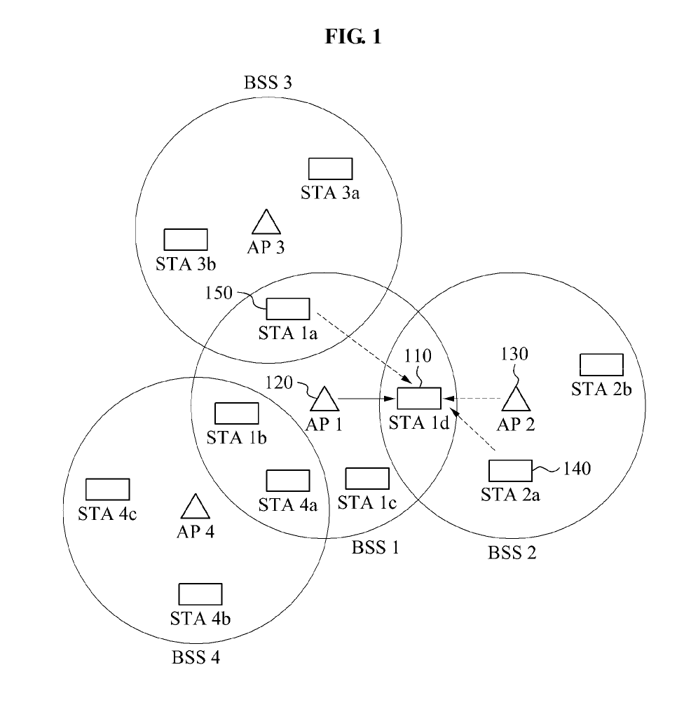

FIG. 1 is a diagram illustrating an interference environment of a wireless local area network (WLAN) system.

Referring to FIG. 1, the WLAN system may include a plurality of access points (APs) and stations (STAs) communicating with the APs.

To perform an interference alignment, a maximum value of “delay spread+synchronization inaccuracy” for each link may need to be less than an orthogonal frequency division multiplexing (OFDM) guard interval, and a period of time required for estimating a channel and reflecting the estimated time may need to be less than a coherence time. For the interference alignment to be efficiently performed in the WLAN system, a process of adjusting synchronizations among the APs may be necessary.

Although the synchronizations are adjusted among the APs, a scheduling may not be performed among the STAs. An STA 1d 110 included in a basic service set (BSS) 1 of an AP 1 120 may communicate with the AP 1 120. However, when another AP or another STA adjacent to the STA 1d 110 is present, communication between the STA 1d 110 and the AP 1 120 may be affected by interference. For example, the STA 1d 110 may be affected by interference of an STA 1a 150 corresponding to an STA identically included in a BSS 1, interference of an AP 2 130 corresponding to the other AP, and interference of an STA 2a 140 included in a BSS 2 corresponding to another BSS. In order to reduce an impact of such interference, a scheduling for uplink and downlink, and a scheduling among transmission times of adjacent BSSs.

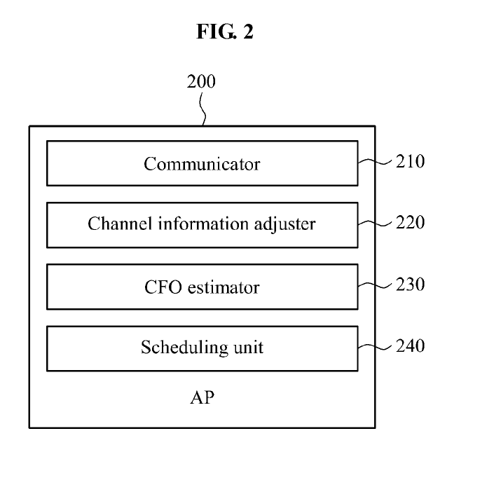

FIG. 2 is a block diagram illustrating a configuration of an AP 200 according to an example embodiment.

A synchronization of the AP 200 may be adjusted with synchronizations of adjacent APs by sharing channel information with the adjacent APs. For example, the AP 200 may share, with the adjacent APs, information on an uplink transmission and a downlink transmission. The AP 200 may adjust a transmission schedule of the AP 200 based on channel information received from the adjacent APs. Through this, a reliability of a time stamp to be used in synchronizations of APs may be enhanced.

Referring to FIG. 2, the AP 200 may include a communicator 210, a channel information adjuster 220, a carrier frequency offset (CFO) estimator 230, and a scheduling m unit 240.

The communicator 210 may broadcast channel information using a beacon. The communicator 210 may broadcast a beacon including time stamp information on a point in time for communication. The communicator 210 may add, to the beacon, time stamp information on a point in time for an uplink transmission and a point in time for a downlink transmission, and transmit the beacon to adjacent APs.

The communicator 210 may receive the beacon from the adjacent APs. The beacon received by the communicator 210 may include channel information on the adjacent APs. For example, a beacon transmitted from an adjacent AP may include time stamp information on a point in time for communication with the adjacent AP.

The channel information adjuster 220 may adjust channel information on the AP 200 based on the beacon received from other APs. The channel information adjuster 220 may adjust time stamp information on a point in time for communication of the AP 200 based on the beacon received from the adjacent APs. The channel information adjuster 220 may extract time stamp information from the beacon received from the adjacent APs. The channel information adjuster 220 may adjust the time stamp information on the AP 200 based on the extracted time stamp information. The channel information adjuster 220 may perform synchronization with the other APs by adjusting a time stamp.

A timing error may occur due to the adjusting and sharing of a timing stamp information using the beacon. The AP 200 may correct a time stamp using a CFO.

The CFO estimator 230 may estimate the CFO using a packet received from a master AP or a controller. The master AP may be selected from among APs existing within an interference alignment range. The CFO estimator 230 may estimate the CFO based on a packet transmitted by the controller through a wired or wireless connection. The packet received from the master AP or the controller may include timing information. The other APs may also estimate the CFO, as well as the AP 200.

The channel information adjuster 220 may readjust the time stamp information based on the estimated CFO. The channel information adjuster 220 may adjust the timing error for each beacon interval based on the estimated CFO. For example, the channel information adjuster 220 may adjust a timing error to be less than 0.5 parts per million (ppm) for each beacon interval based on a CFO. As another example, when a beacon interval is 100 microseconds (μs), the channel information adjuster 220 may adjust a timing error to be less than 50 nanoseconds (ns) for each beacon interval.

The scheduling unit 240 may schedule a timing between the AP 200 and the other APs. Also, the scheduling unit 240 may schedule a timing between the AP 200 and an STA connected to the AP 200. The scheduling unit 240 may perform a scheduling between an uplink transmission and a downlink transmission, and a scheduling between a transmission time of the AP 200 and a transmission time of an adjacent AP. The scheduling unit 240 may perform a scheduling based on a slotted carrier sense multiple access (CSMA).

The scheduling unit 240 may allocate a time interval to be used by an STA and a predetermined STA group. For example, the scheduling unit 240 may allocate a time interval to be used by the STA, to a restricted access window (RAW). The scheduling unit 240 may classify slots in the RAW and allocate, to the slot, the uplink transmission or the downlink transmission of a predetermined STA having a transmission opportunity. Through this, the AP 200 may identify an interference signal available at an identical point in time in an identical BSS and an adjacent BSS. The scheduling unit 240 may incorporate scheduling information to a signal sequence of the AP 200. For example, the scheduling information may include information on an STA and information on a time interval to be used by the STA. The communicator 210 may transmit a beacon including the scheduling information to an adjacent AP. The scheduling unit 240 may acquire scheduling information on the adjacent BSS based on scheduling information received from another AP. Sharing of scheduling information including a value obtained after a beacon interval may be desirable, and depending on a case, a communication time may be scheduled without an overlap among APs.

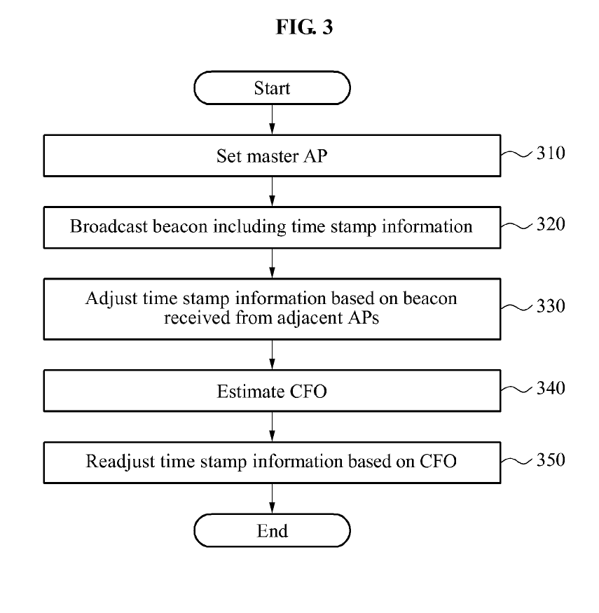

FIG. 3 is a flowchart illustrating a method of sharing of channel information according to an example embodiment. Referring to FIG. 3, a channel information sharing method applied to a case of performing an interference alignment without a separate controller may be indicated. An AP may adjust synchronization among APs by sharing channel information with adjacent APs.

In operation 310, the AP may set a master AP among the adjacent APs. The master AP may be selected from among APs existing within an interference alignment range. For example an AP including a global positioning system (GPS) may be set to be the master AP.

In operation 320, the AP may broadcast a beacon including time stamp information on a point in time for communication. The AP may add, to the beacon, time stamp information on a point in time for uplink transmission and a point in time for downlink transmission, and transmit the beacon to the adjacent APs.

In operation 330, the AP may adjust the time stamp information on a point in time for communication based on the beacon received from the adjacent APs. The beacon transmitted from the adjacent APs may include time stamp information on a point in time for communication pertaining to each of the adjacent APs. The AP may extract time stamp information from the beacon received from the adjacent APs. The AP may adjust time stamp information on the AP based on the extracted time stamp information. The AP may perform synchronization with other APs by adjusting a time stamp.

In operation 340, the AP may estimate a CFO using a packet received from the master AP. The received packet may include timing information on a point in time for communication.

In operation 350, the AP may readjust time stamp information based on the estimated CFO. The AP may adjust a timing error for each beacon interval based on the estimated CFO.

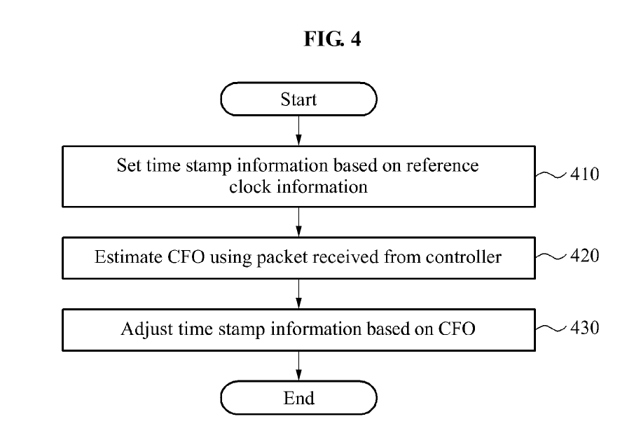

FIG. 4 is a flowchart illustrating a method of sharing of channel information according to another embodiment. Referring to FIG. 4, a channel information sharing method used for interference alignment in a case in which a separate controller is provided to control APs may be indicated.

In operation 410, an AP may set time stamp information on a point in time for communication based on reference clock information received from a controller. The AP may have a wired or wireless connection to the controller. When the controller is provided, an operation, for example, operation 310 of FIG. 3, of setting a master AP may not be required.

In operation 420, the AP may estimate a CFO using a packet received from the controller. The packet received from the controller may include timing information, and have a configuration similar to a beacon.

In operation 430, the AP may adjust time stamp information based on the estimated CFO. The AP may adjust a timing error for each beacon interval based on the estimated CFO.

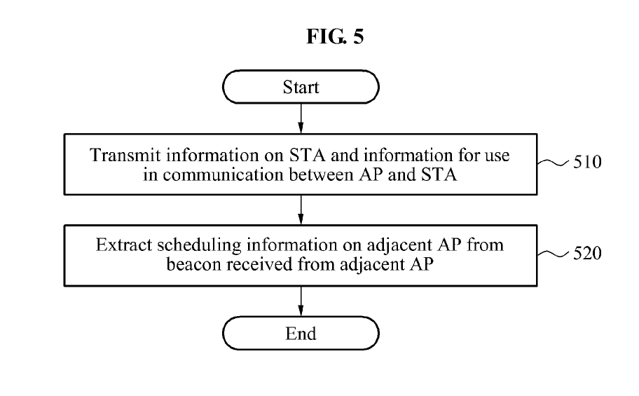

FIG. 5 is a flowchart illustrating a method sharing of channel information according to still another embodiment.

In a WLAN system, interference may simultaneously occur in a number of interference signals. An AP may improve an effect of an interference alignment by scheduling between an uplink and a downlink in an identical BSS, and scheduling a transmission time between adjacent BSSs.

In operation 510, the AP may transmit, to an adjacent AP, information on an STA connected to the AP and information for use in communication between the AP and the STA. The information for use in communication between the AP and the STA may include information on an RAW allocated to the STA and a slot allocated in the RAW. The slot may indicate a time interval for use in an uplink data transmission or a downlink data transmission.

In another example embodiment, an AP may generate a frame including at least one of address information on the AP, address information on an STA connected to the AP, information on a number of antennas of the AP, and transmission stream information. Subsequently, the AP may transmit the generated frame to the STA or an adjacent AP.

In operation 520, the AP may extract scheduling information on the adjacent AP from the beacon received from the adjacent AP. The AP may adjust a transmission timing of the AP and a transmission timing of the STA based on the extracted scheduling information on the adjacent AP.

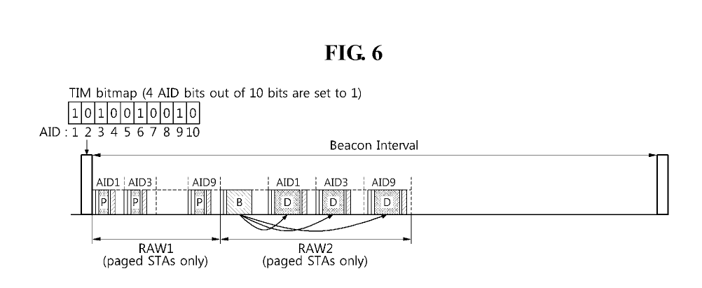

FIG. 6 is a diagram illustrating a process of using a slotted CSMA to perform interference alignment according to an example embodiment.

Referring to FIG. 6, an RAW1 and an RAW2 may be set in a beacon interval, and a plurality of slots may be allocated in the RAW1 and the RAW2. “P” of the RAW1 may indicate a slot for a poll. In the RAW2, “B” may indicate a slot for a broadcast, and “D” may indicate a slot for a downlink transmission or an uplink transmission. A slot for acknowledgement (ACK) message transmission may be allocated subsequent to the slot for the poll and the slot for the downlink transmission. The AP may allocate, to an RAW, a time interval to be used by an STA. The AP may classify slots in the RAW and allocate, to the slot, a downlink transmission or an uplink transmission of a predetermined STA having a transmission opportunity.

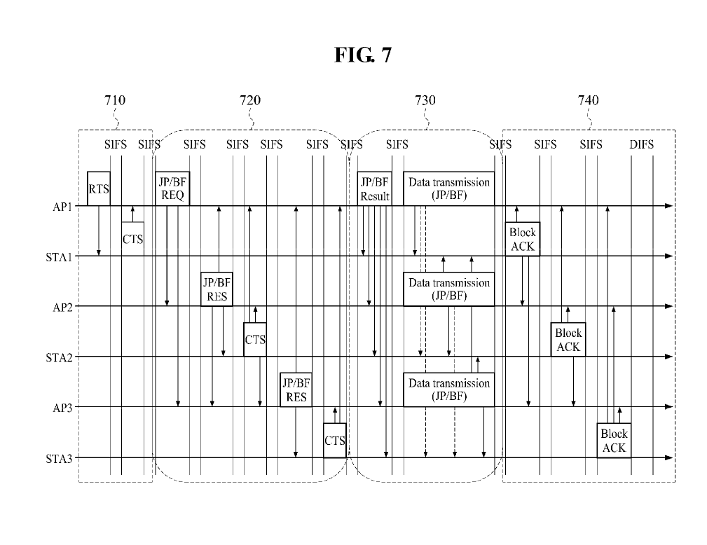

FIG. 7 is a diagram illustrating an example of a protocol for use in channel information sharing according to an example embodiment. Referring to FIG. 7, a medium access control (MAC) protocol for use in a distributed transmission performed for an interference alignment in a WLAN system may be indicated. The MAC protocol may be used for the interference alignment and cooperative communication, and include a process of implicitly or explicitly feeding back distributed channel information.

The MAC protocol may include a first interval 710, a second interval 720, a third interval 730, and a fourth interval 740.

In the first interval 710, a predetermined AP may acquire a transmission opportunity. In the second interval 720, a process of responding and cooperative communication for interference alignment may be performed. In the third interval 730, a final communication method may be determined and data may be transmitted. In the fourth interval 740, an ACK message of each STA may be transmitted.

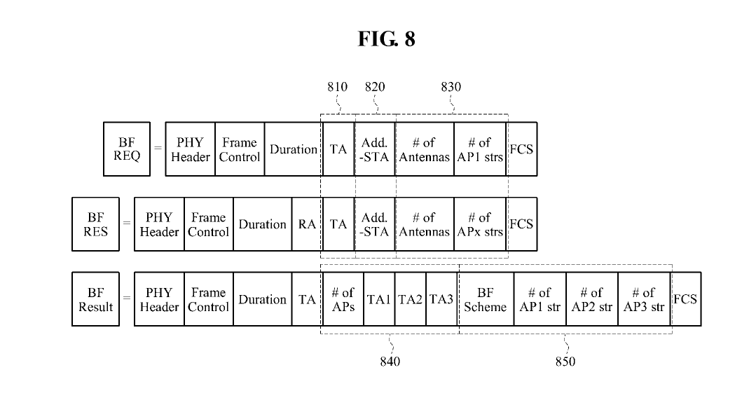

FIG. 8 is a diagram illustrating a frame for use in channel information sharing according to an example embodiment. Referring to FIG. 8, a frame format of a MAC data packet for use in an interference alignment in a WLAN system may be indicated. The frame format may include an additional field and be used while maintaining a compatibility with an existing WLAN system.

The frame format may include a first field 810, a second field 820, a third field 830, a fourth field 840, and a fifth field 850.

The first field 810 may include address information on an AP participating in cooperative communication. The second field 820 may include address information on an STA connected to each AP. The third field 830 may include information on a number of antennas and transmission stream information. The fourth field 840 may include information on a number of APs participating in the cooperative communication, and address information on each of the APs. The fifth field 850 may include beamforming (BF) scheme information and information on a number of transmission streams of each AP.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of sharing channel information performed by an access point (AP), the method comprising:
setting a master AP among adjacent APs;
adjusting time stamp information on a point in time for communication based on a beacon received from the adjacent APs;
estimating a carrier frequency offset (CFO) using a packet received from the master AP; and
readjusting the time stamp information based on the estimated CFO.

2. The method of claim 1, wherein the adjusting comprises extracting time stamp information from the beacon received from the adjacent APs, and
adjusting time stamp information on the AP based on the extracted time stamp information.

3. The method of claim 1, wherein the readjusting comprises adjusting a timing error for each beacon interval based on the estimated CFO.

4. The method of claim 1, further comprising:
broadcasting a beacon including time stamp information on a point in time for communication.

5. The method of claim 1, wherein the packet comprises timing information on a point in time for communication.

6. The method of claim 1, wherein the setting comprises setting an AP including a global positioning system (GPS) sensor as the master AP.

7. A method of sharing channel information performed by an access point (AP), the method comprising:
transmitting, to an adjacent AP, information on a station (STA) connected to the AP and information for use in communication between the STA and the AP; and
extracting scheduling information on the adjacent AP from a beacon received from the adjacent AP.

8. The method of claim 7, wherein the information for use in communication between the AP and the STA comprises information on a restricted access window (RAW) allocated to the STA and a slot allocated in the RAW.

9. The method of claim 8, wherein the slot indicates a time interval used for an uplink data transmission or a downlink data transmission of the STA.

10. The method of claim 7, wherein the transmitting comprises generating a frame including at least one of address information on the AP, address information on the STA connected to the AP, information on a number of antennas included in the AP, and transmission stream information, and
transmitting the generated frame to an STA or an adjacent AP.

11. An access point (AP) comprising:
a channel information adjuster to adjust time stamp information on a point in time for transmission based on a beacon received from adjacent APs; and
a carrier frequency offset (CFO) estimator to estimate a CFO using a packet received from a master AP or a controller,
wherein the channel information adjuster readjusts the time stamp information based on the estimated CFO.

12. The AP of claim 11, wherein the channel information adjuster extracts the time stamp information from the beacon received from the adjacent APs, and adjusts time stamp information on the AP based on the extracted time stamp information.

13. The AP of claim 11, wherein the channel information adjuster adjusts a timing error for each beacon interval based on the estimated CFO.

14. The AP of claim 11, further comprising:
a communicator to broadcast a beacon including time stamp information on a point in time for transmission.

15. The AP of claim 11, further comprising:
a scheduling unit to perform a scheduling between an uplink transmission and a downlink transmission, and a scheduling between a transmission time of the AP and a transmission time of an adjacent AP.
